(19) United States
(12) Patent Application Publication
(10) Pub. No.: US 2010/0008648 A1
(43) Pub. Date: Jan. 14, 2010

(54) AUDIO ONLY PLAYBACK OF A DISK HAVING BOTH AUDIO AND VIDEO RECORDINGS

(75) Inventors: Ruban Sivakumar, Fremont, CA (US); Anoop Balakrishnan, Fremont, CA (US); John Crosbie, Fremont, CA (US); Shrikant Acharya, Fremont, CA (US); Oleg Matcovschi, Fremont, CA (US)

Correspondence Address: THE ECLIPSE GROUP LLP, 10605 BALBOA BLVD., SUITE 300, GRANADA HILLS, CA, 91344, US

(73) Assignee: Harman International Industries, Incorporated, Northridge, CA (US)

(21) Appl. No.: 12/172,929

(22) Filed: Jul. 14, 2008

(51) Int. Cl. H04N 5/91

(52) U.S. Cl. 386/106

(57) ABSTRACT

A system and method for playing audio only in a disk player. The disc player is configured to read data from disks formatted according to a selected audio and video standard. The system includes a file reader to read files of audio and video files based on the audio and video standard. A stream parser identifies audio data, video data and sub-picture data. An audio decoder decodes the audio data according to the audio standard. A video stub receives the video data and leaves the video data unprocessed. A sub-picture menu processor extracts menu information. A user interface system to use the menu information to configure at least one user input to play audio-only from the disk according to the menu information.

### FIELD OF THE INVENTION

The present invention relates generally to audio systems, and more particularly, to systems and methods for processing media on a video disk to playback audio.

### BACKGROUND

Audio and video electronic content is commonly recorded on media storage disks. The DVD (“Digital Versatile Disk” or “Digital Video Disk”) format is a widely used format for the reproduction of movie titles. Movie producers and distributors offer DVDs containing movies for consumers to view in their homes on their DVD players.

Users may at times wish to listen to audio on a DVD without viewing the video. For example, a user may wish to listen to the audio from a DVD containing video of a music concert. The user may also want to listen to the audio of the DVD while driving or in any other situation in which a display of the video would be dangerously or inconveniently distracting. While in operation in a typical DVD player, the DVD video uses visual navigation stimuli to direct the DVD player to perform the kind of playback the user desires. The visual navigation stimuli may contain image buttons, or selectors, or active image areas, that when selected, direct the DVD player to play, for example, the movie, view directors cuts, search for a specific point in the video, or jump to a specific scene. This approach is largely manual as it requires the user to make selections using a remote or buttons on the player.

In a typical DVD player, the user selects specific material to play by selecting from the options provided on the screen. When there is no video output in the system, the user is left with no means for selecting any audio to play from the DVD. There is a need for a way to provide a user with a mechanism for selecting audio to play from the DVD without reliance on a display.

One problem is that DVD video does not contain any meta data on the disk. There are standard references to track numbers as with a CD (for example, track numbers). But, the track numbering for video material access is not precise due to user prohibitions. A user prohibition is an action in which the DVD player prohibits execution of any user commands during playback of a specific section of video data. One example of a section of video data that typically includes a user prohibition is the “FBI warning” typically recorded at the beginning of the recorded material in a DVD. Another instance of user Prohibition is not to allow any track changes during a play session e.g. for a change of language except through the main menu. Some disks have several audio language options which can only be accessed through the main menu.

There is a need in the art for improved systems and methods for providing audio playback of a DVD without video.

### SUMMARY

In view of the above, an example system is provided for playing audio only in a disk player. The disc player is configured to read data from disks formatted according to a selected audio and video standard. The system includes a file reader to read files of audio and video files based on the audio and video standard. A stream parser identifies audio data, video data and sub-picture data. An audio decoder decodes the audio data according to the audio standard. A video stub receives the video data and leaves the video data unprocessed. A sub-picture menu processor extracts menu information. A user interface system to use the menu information to configure at least one user input to play audio-only from the disk according to the menu information.

Further in view of the above, an example method is provided for method for audio-only playback of a disc having audio and video information. Audio and video information is parsed to identify video information, audio information and sub-picture data. The audio data is decoded and the video information is left unprocessed. Menu information in the sub-picture data is extracted and used to obtain audio track information. The audio track information is stored and the audio track information is associated with user input in a database. The user input is received from a user to select an audio track to play and initiating playback at the audio track.

Other systems, methods, features and advantages of the invention will be or will become apparent to one with skill in the art upon examination of the following FIGS. and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1A is a block diagram of an example system for processing audio data in a DVD player.

FIG. 1B is a front view of an example user interface panel that may be used to provide audio-only playback of a DVD.

FIG. 1C is a block diagram of an example of a user interface control system for retrieving user instructions for audio-only playback of a DVD disk.

FIG. 2 is a diagram of a data layout of a DVD disk.

FIG. 3 is a block diagram illustrating the software framework of an example of a system for providing audio-only playback of a DVD disk.

FIG. 4 is a flowchart depicting operation of an example method for processing audio-only playback of a DVD disk.

FIG. 5 is a flowchart depicting operation of a user interface to a system for providing audio-only playback of a DVD disk.

### DETAILED DESCRIPTION

In the following description of examples consistent with the invention, reference is made to the accompanying drawings that form a part of, and which show, by way of illustration, specific examples in which the invention may be practiced. Other implementations may be utilized and structural changes may be made without departing from the scope of the present invention.

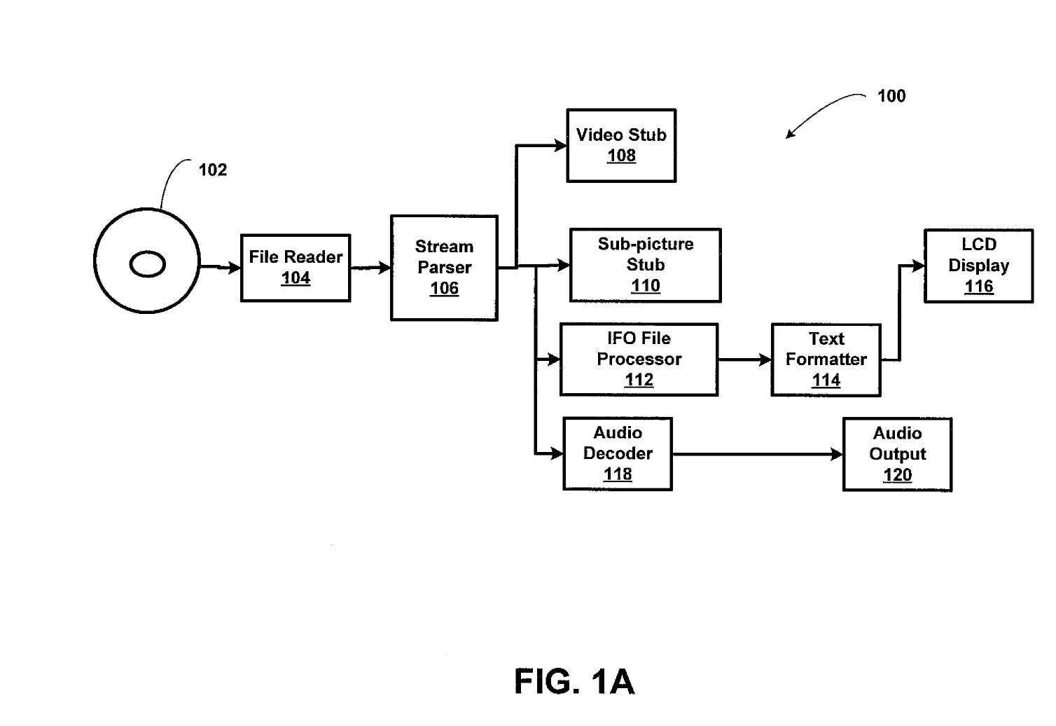

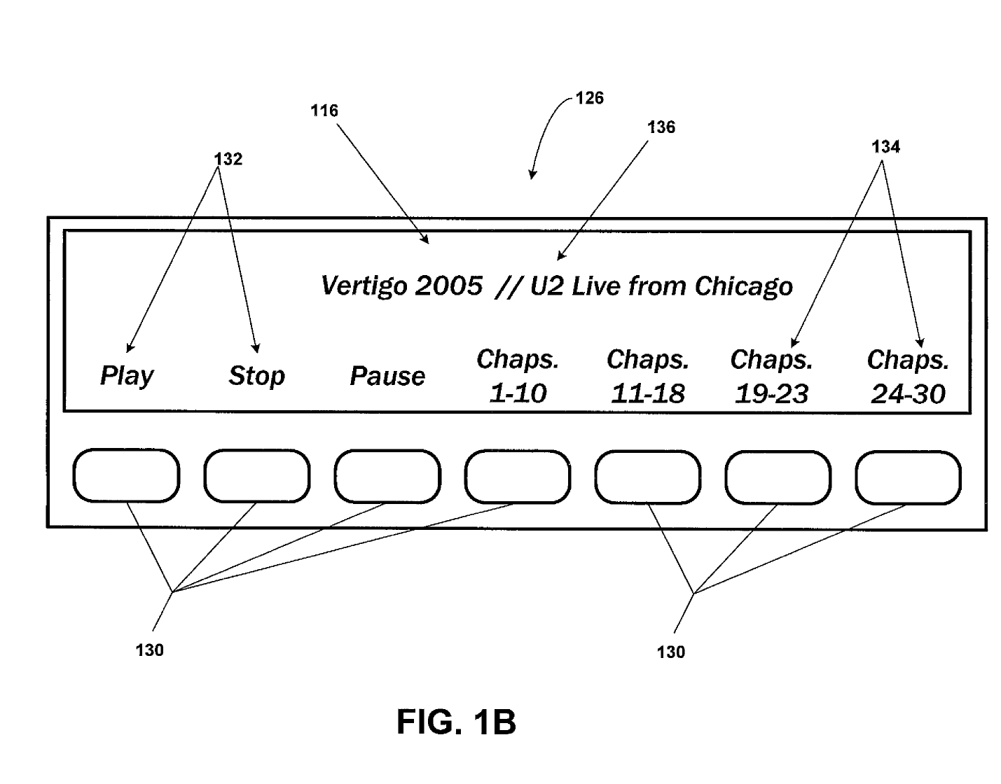

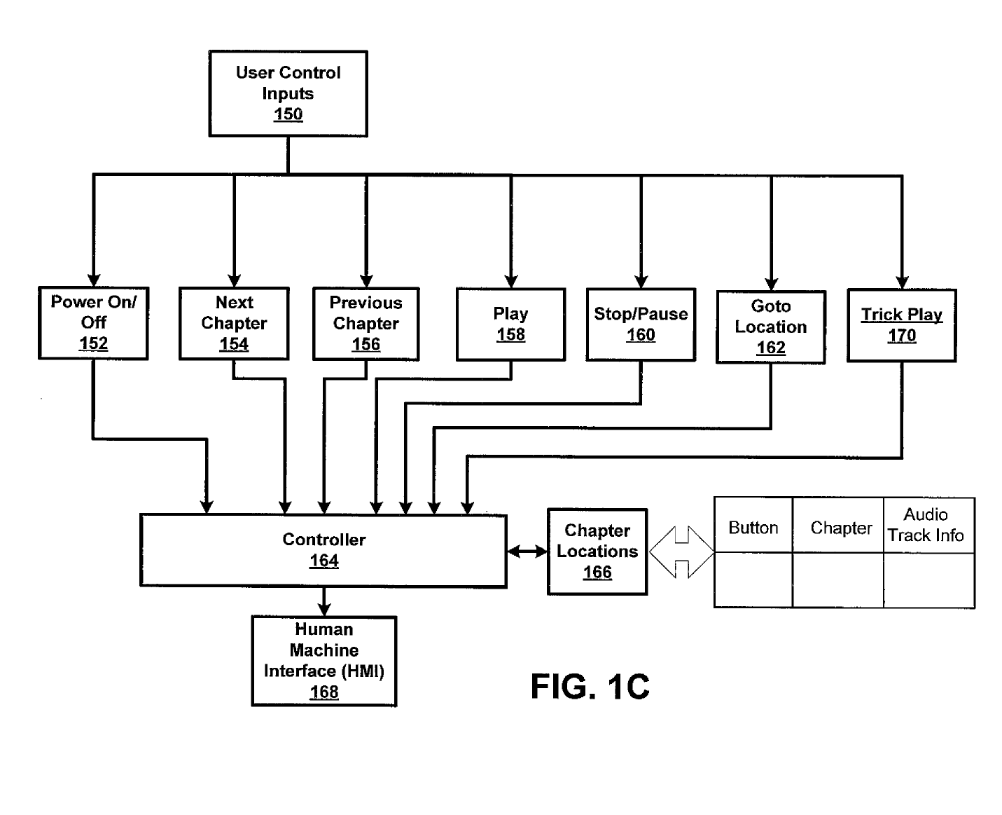

FIG. 1A is a block diagram of an example system 100 for processing audio data that may include sub-picture image data. In the example system in FIG. 1A, the DVD Menu navigation process is automated in order to allow the playback of the audio content of a DVD video disk title. The system 100 pertains to a special case of the DVD player environment where only the audio content of the DVD Video disk is played for the benefit of the listener, which may be particularly useful inside an automobile. The DVD player may be any disk reader-based system equipped to provide audio, such as a CD player, that is also capable of reading DVD-based disks.

The system 100 in FIG. 1A includes a DVD drive and read head assembly 102, a file reader 104, an audio-only stream parser 106, a video stub 108, a sub-menu stub 110, an IFO file processor 112, a text formatter 114, an LCD display 116, an audio decoder 118, and an audio output 120. The example system 100 in FIG. 1A is described below in the context of a system for decoding audio and video of a DVD Video Disk according to “DVD Specifications for Read-Only Disc, Part 3, VIDEO SPECIFICATIONS, Version 1.13, March 2002,” which is incorporated herein by reference. A DVD Video Disk may contain, for example, a movie stored as compressed audio and video data. The disk may also include features such as a user interactive menu, sub-titles stored as image data and one or more audio data tracks. The movie image data may be stored separate from the features image data as a “Title.” An interactive menu may be played out of sub-picture data independent of the movie data. Using the interactive menu, the user may select features and/or control the location from which the movie is played. With respect to the selection of features, when the movie is played, the movie video data may be mixed with the sub-picture data and a selected audio data track according to the user's selection. The user may also select to play the movie from its beginning in the interactive menu, or from several other locations, such as “chapters” in the movie title.

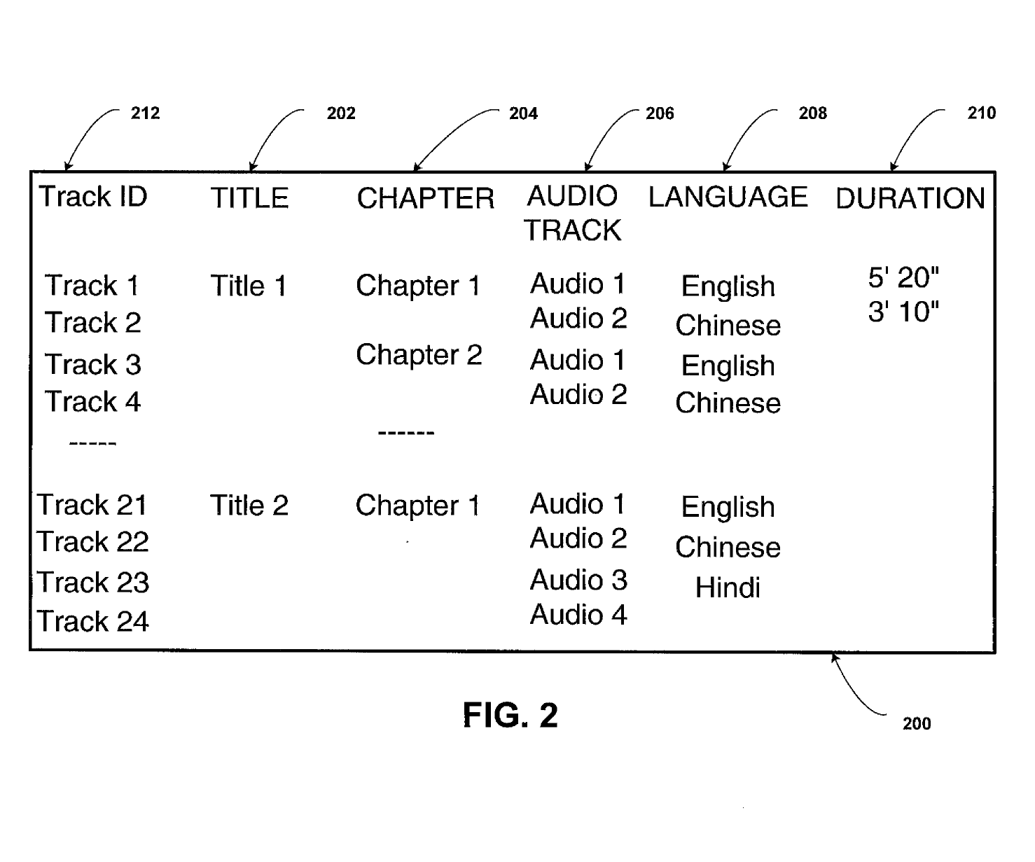

The DVD player may be operated in at least one of two modes. In one mode, the DVD player receives a DVD disk and begins playing audio at the location of the main title. In the other mode, the user is provided with a user interface as described below with reference to FIG. 2 to control selection of the audio played. In addition, DVDs may be configured to automatically play at the main title and may not include menu information. In such a case, the player operates in only the first mode.

In the example system 100 in FIG. 1A, the file reader 104 receives the DVD-formatted data on the DVD disk. The file reader 104 communicates the DVD-formatted data to the stream parser 106, which analyzes a DVD video stream and parses out streams of sub-picture information, main video information and audio information. The stream parser 106 may further sub-divide the sub-picture information as interactive menu data and all other sub-picture data. The example system 100 decodes the DVD media packets according to the DVD specifications. The DVD data is received as a pack of video, audio and sub-picture and the IFO file. The stream parser 101 identifies the packets in the DVD pack and extracts the different types of packets for processing according to the standard that defines each type of packet.

The system 100 in FIG. 1A is used to play audio on a DVD disk. The video information is communicated to a video stub 108, which need not include a video decoder. The sub-picture data is communicated to a sub-picture data stub 110. The IFO file information is passed to the IFO file processor block 112. The audio data is communicated to an audio decoder 118, which decodes the audio data according to any of the Linear PCM, Dolby AC-3, MPEG audio DTS or SDDS standards.

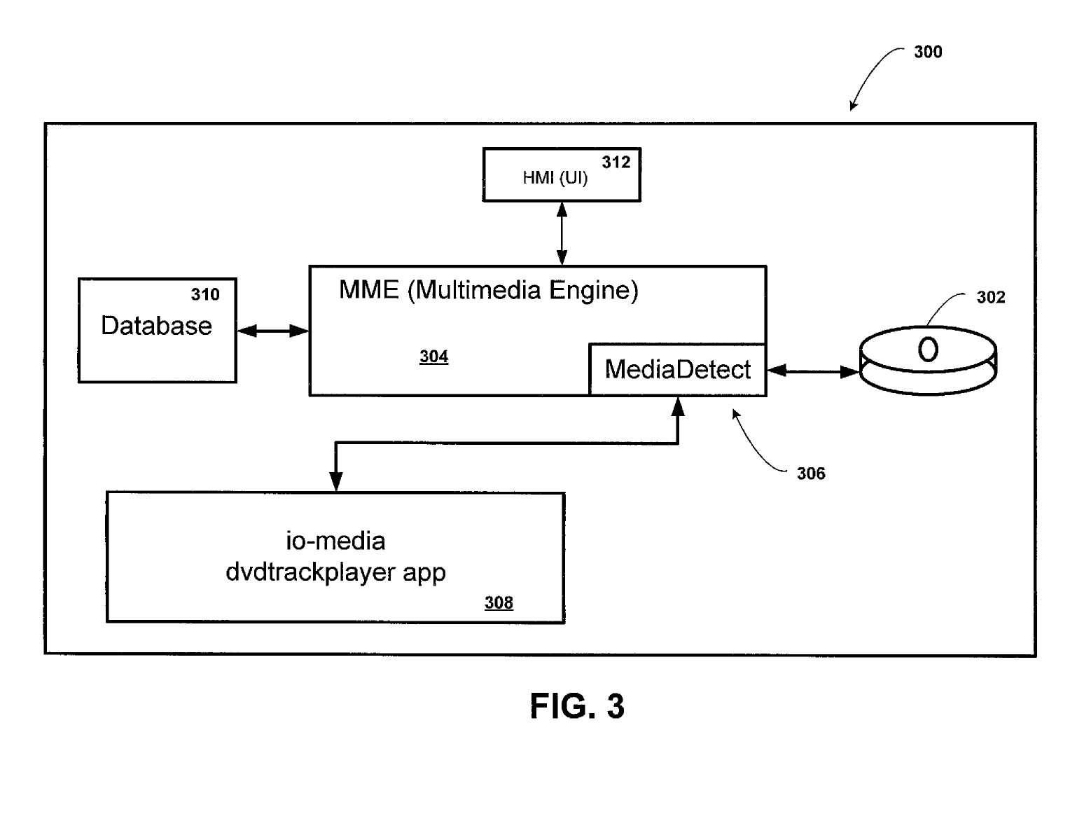

With respect to the IFO File data, the stream parser 106 extracts this information from the DVD disk and passes it to the IFO file processor block 112. The IFO file processor block 112 may then extract Title, chapter, audio streams which could further contain information such as languages or decoding modes. For example, DTS, AC3 and duration of the audio tracks. The IFO file processor then creates a database of track IDs for the various audio tracks which are matched for the specific language and decoding classification. The track IDs also further classified by the Title and the chapters to which they are associated. From this database a track session is created based on user preferred audio stream selection. This track session becomes the user displayable selector information which may or may not be the complete database information. This limited set of audio track data or track session is now available for display. Once identified, the text is communicated to a text formatter 114. The text formatter 114 outputs text to a text-based display 116 for display to the user. The text-based display 116 may be an LCD display, an LED display or any other non-video display configured with buttons or switches placed adjacent or near areas on which text may be displayed on the text-based display 116. Although IFO File processor is indicated as a single block for purposes of illustrating operation. In example implementations, the IFO file parsing may entail other functions as illustrated, for example, in FIG. 3. IFO file parsing functions may be performed by the MME layer 304 for user display of track details while the IFO parsed information may be used in the “iomedia dvdtrackplayer” application shown at 308 in FIG. 3.

It is noted that reference to the text-based display 116 as an LCD display is purely for purposes of illustration. The text-based display may be any suitable non-graphic or video display.

FIG. 1B is a front view of an example user interface panel that may be used to provide audio-only playback of a DVD. The user interface includes the LCD display 116 and a set of buttons 130. The LCD display 116 is shown to display functions corresponding to the buttons 130. For example, a “Play” and a “Stop” at 132 correspond to two of the buttons 130. The LCD display 116 may include media locations 134 identified as chapters or sets of chapters or portions of the work recorded on the media of the DVD. The media locations 134 correspond to buttons 130 configured to transfer the play of the DVD to the location identified by the media location 134 on the display 116. The buttons 130 may be programmed or configured to signal a controller of the DVD player to position the read head at a location on the DVD that corresponds to the selected media location.

The programming or configuring of the buttons 130 may be performed when the IFO file processor 112 creates the track session. The controller may also relate the buttons to text that is being formatted for display on the LCD display 116. When the buttons 130 are configured and the text displayed on the LCD display, the DVD player may receive user instructions.

FIG. 1C is a block diagram of an example of a user interface control system 140 for retrieving user instructions for audio-only playback of a DVD disk. The user interface control system 140 includes user control inputs 150, a power on/off control 152, a next chapter control 154, a previous chapter control 156, a play control 158, a stop/pause control 160, a go to location control 162, trick play control 170, a controller 164, a chapter locations database 166, and a human-machine interface (HMI) 168. The user control inputs 150 includes the buttons 130 described above with reference to FIG. 1B. The user control inputs 150 connect to functions 152, 154, 156, 158, 160, 162, 170 performed in response to selection of the user control inputs 150.

The functions 152, 154, 156, 158, 160, 162, 170 may be configured each time a DVD is inserted into the DVD player. For example, when the DVD is inserted into the DVD player, a file is detected and read to configure the play of the DVD. The configuration may include retrieving the track session database created by the IFO file processor, which would typically be displayed on a video display. The example DVD player described with reference to FIGS. 1A-1C includes an LCD display 116 and not a video display. Therefore, the configuration may also include programming the user control inputs 150 by assigning functions 152, 154, 156, 158, 160, 162, 170 to selected user control inputs 150 and configuring the specific operation of the functions 152, 154, 156, 158, 160, 162, 170. The configuration may also include retrieving the audio track locations on the DVD disk associated with track session database containing audio track information that may be used to play at the indicated media location on the DVD. The media locations and audio track information may be associated with buttons and stored in the chapter locations database 166 for retrieval when needed to re-position the reader on the DVD.

The functions 152, 154, 156, 158, 160, 162, 170 are connected to the controller 164, which control operation associated with the functions 152, 154, 156, 158, 160, 162, 170. With respect to the next chapter function 154, the previous chapter function 156, and the go to location function 162, trick play function 170 such as, for example, Fast Forward, Fast Backward, the controller 164 may receive an indication that the user has selected one of the functions. The controller 164 may then retrieve a corresponding audio track information from the chapter locations 166 and use the information to control the disc player interface 168 to play at the location indicated by the audio track information. For example, the user may press the button 130 associated with chapters 19-23, as shown in FIG. 1B. The go to location function 162 may communicate a specific button identifier to inform the controller 164 of the button selected. The button identifier may be used to retrieve the track ID corresponding to the audio track information. The audio track information may be communicated to the HMI 168. The HMI 168 controls the hardware and software associated with positioning the read head at the appropriate location on the DVD disk to begin playing the media at the location.

FIG. 2 is a diagram of a track session data base layout 200 of a DVD disk contained in the IFO File. The data layout 200 organizes media on a DVD as track IDs 212 associated with titles 202 and its associated chapters 204 and audio tracks 206. For example, the title 202 may include all of the media associated with a movie or a recorded conceit or other type of video work. DVDs may include more than one title 202 on a single disk. The video work, or title 202, may be further divided into chapters 204. Chapters 204 are sequentially organized portions of the title 202. Chapters 204 are defined to allow a user to skip to specific parts of the title on the DVD. Each chapter 204 includes an audio track 206, a language 208 for each track 206, and a time duration 208 specifying in minutes and seconds (or other time increments) the length of the audio track 206.

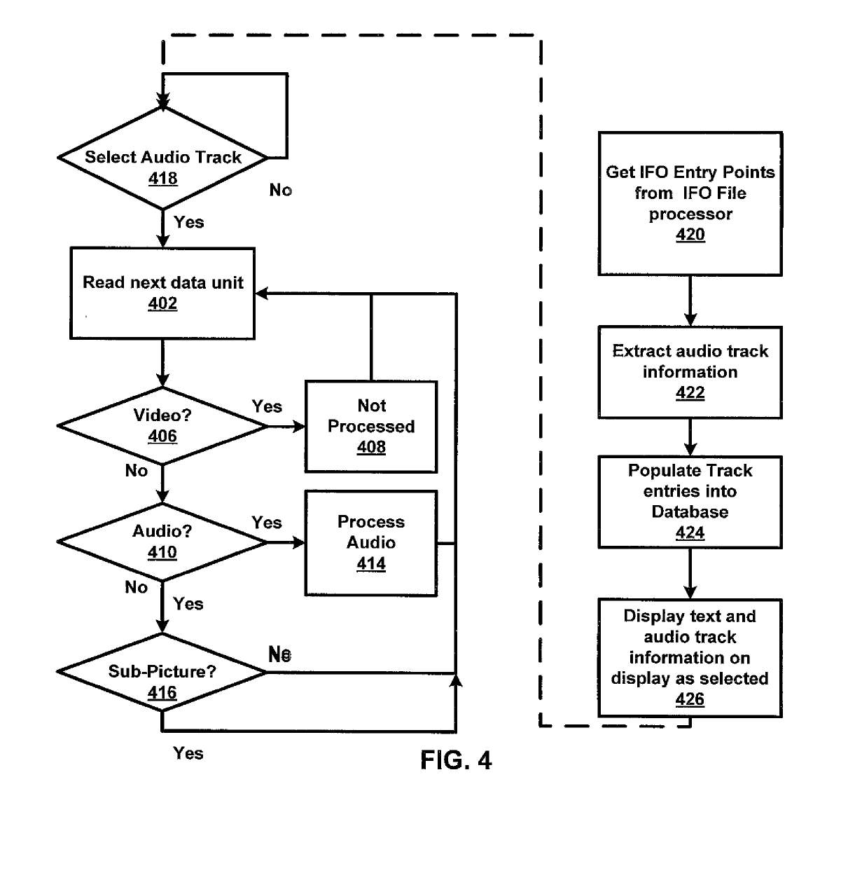

The information provided by the data layout 200 is passed to the HMI 168 (in FIG. 1C) and used to allow a user to navigate to different parts of a title 202. The audio track information may not be displayed to the user as audio tracks if a language has not been set as the default language. Once the user has selected a default language, the audio track information will be displayed in the selected language by reference to the database. For example, if Track1 is English then for each chapter only the English track will be itemized. In the illustrated example, the English track is Track1 for Chapter 1 and Track3 for Chapter 2 etc. For further reference this data is collected at 424 and then passed on to 418 via 426 in FIG. 4.

For example, chapters 204 identify where an audio track 206 on a DVD begins. When a DVD is inserted into the DVD player, the DVD disk commences playback from the information available in a file called FP_PGC (First Play Program Chain). This first play program chain may default to automatic play of the title, or it may be connected to another file called VMGI_PGC (Video Manager Menu Information). The VMGI_PGC can provide the information relating to the title track to be played. The DVD will typically begin play by playing the Title Menus.

In some example implementations of the DVD audio-only playback system, an operating mode may be provided that bypasses the playing of the DVD Title Menus and jumps directly to the file for playing the Main Title PGC (TT_PGC) (the Main Title number can be extracted from the VMGI) and start playing the title without menus. This operating mode may be optional. The direct play of the DVD would not permit a user to skip up or back to different chapters, or sections of the DVD.

Some DVD disks contain several small movie trailers. The VMGI file may provide the title set number and the title number for the main title. The first number in the title set may be the default main title. The first number in the title set may be used to skip the trailers and go on to play the real title.

While the audio track is being played (in track player mode), the PRE (PGC) Command and the POST (PGC) Navigation commands may be disabled to avoid looping into a menu domain and permit the playback of the user-requested track. For example, when a DVD title is inserted into a player, there is a possibility that as soon as the menu is displayed, the PGC would direct the control of the playback to remain in the menu domain. Similarly, once a title has completely played, it could revert to loop-in in the menu domain. When listening to the audio-only, it may be desirable to keep playing the next track. This may be accomplished by disabling menu looping to allow the program to take control and play the track.

In another example, a given track may have infinite still timer intervals that can prevent the end of an audio track. This feature is also disabled in audio track playback with no video present.

In an example system, an IFO parser, which is a function that parses an IFO file (information file), may be included to collect the information about the available titles, chapters, the number of audio streams, the format specification of the streams. DVD disks typically include an IFO extension, which provides an index into the Audio and Video “.TS” file extensions (VIDEO_TS.IFO and AUDIO_TS.IFO). These files contain information and data structures that instruct the player how to play back the inserted disk. The information may then be presented to the user so that even if the navigation execution commands embedded in the stream cannot be used without a video recorder, the user may be provided with commands to play different chapters.

FIG. 3 is a block diagram illustrating the software framework 300 of an example of a system for providing audio-only playback of a DVD disk when the disk is inserted in a DVD drive 302. The software framework 300 may include a multi-media engine (MME) 304 and a media detect module 306, which includes the IFO parser program described above as part of a media parser program and the database block 310, which contains among other things the track session database. The software framework may also include a dvdtrackplayer application 308, which may be part of the io-media software block. The dvdtrackplayer application 308 may issue commands to the MME 304 to provide it track information from the database 310, for a DVD disk inserted into the DVD drive 302. The track information is also passed to a human-machine interface (HMI) 312 to display or otherwise provide the information on the user interface for the user to select as described above, for example, with reference to FIGS. 1A-1C.

FIG. 4 is a flowchart depicting operation of an example method for processing audio-only playback of a DVD disk. An example method depicted may be implemented in the system shown in FIG. 1A. In the system shown in FIG. 1A, the file reader 104 inputs file information from the disk 102. The file information is read in at step 402. The file information is checked at decision block 406 for video information. If the file information is video information, the file information is not processed as shown at step 408 and the next data unit is read in at step 402.

The file information is then checked for audio information as shown at decision block 410. If the file information is audio, the audio data is processed at step 414 as described above and the next data unit is read in at step 402. If the file information is not audio data, the file information is checked at decision block 416 for sub-picture data. If the file information does not include sub-picture data, the next data unit is read in at step 402. If the data information contains sub-picture information then it is skipped over as well. At step 420, the IFO File processing information commences. The audio track information is extracted in step 422 and a track session database is created in step 424. Using user selection settings the track session database in 424 is refined to create the limited audio track data set for presentation. At step 426, the information is displayed on the LCD display. Step 426 may include configuring a set of inputs, or buttons to correspond with the text displayed on the LCD display. Control returns to step 418 to select the first audio track indicated by the user selected button and auto select subsequent tracks when the previous track is completed. Steps 420-426 may only need to be performed once-during the disk initialization for each DVD played.

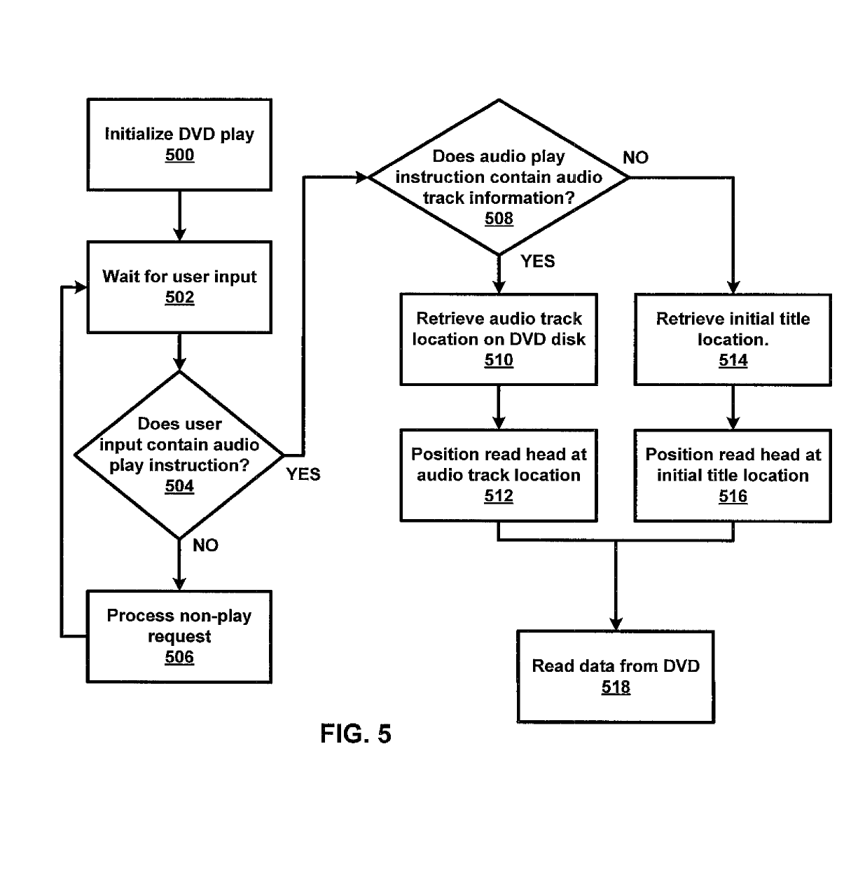

FIG. 5 is a flowchart depicting operation of a user interface to a system for providing audio-only playback of a DVD disk. When a user inserts a disk into the DVD player, the DVD player performs an initialization at step 500. The initialization in step 500 may include reading from a default position on the disk to search for and retrieve a VIDEO_TS.IFO and/or AUDIO_TS.IFO file. As described above with reference to FIG. 2, the files contain information and data structures that instruct the player how to play back the inserted disk. The information in the VIDEO_TS.IFO and/or AUDIO_TS.IFO may be used when the IFO file processing information is processed as described above, for example, with reference to FIG. 4 steps 420-426. The initialized disk may now be ready to play in one of two operating modes. In one, the disk player may be configured to begin playing the main title automatically without providing the user with the ability to skip from one chapter to another. In another mode, the disk player may have menu information that may be displayed on a text display, such as a LCD display. Buttons and/or other types of inputs may be configured to provide the user with various play functions. A third mode may be implemented in some example players that provide audio-only playback implements a gapless playback of the audio tracks in a DVD Video file. In a gapless playback, the playback mechanism has advance information about the next track to play and the stream is already in the pipeline for playback so that user does not see a drop in the audio when track switches occur. As shown in FIG. 5, when the disc is inserted the first entry in the track session database is (Title 1, Chapter 1) is provided as input to the dvdtrackplayer function 308 (in FIG. 3). As the first input starts playing the next input is provided in advance (before the current track ends). This sequence continues until all selected tracks are played.

Once initialization is complete at step 500, the DVD player may wait for a user input at 502. The DVD player may wait for a “Play” input from the user. At decision block 504, an input user instruction is checked for a play instruction. If the instruction is not a “Play” instruction, the input instruction is processed and control returned to wait for user input at step 502.

A “Play” instruction from the user may be in one of a variety of forms. For example, the user may have pressed a button configured to play the DVD audio starting at a particular chapter. The user may also have pressed a skip chapter or previous chapter button. When the “Play” instruction is received, it is checked at decision block 508 to determine if there is also audio track information associated with the “Play” instruction. If there is audio track information, the audio track location, or media location, associated with the information is retrieved, for example, from a database at step 510. At step 512, the read head is positioned over the identified location. At step 518, data is read from the DVD at that location. If the “Play” instruction did not include audio track information, the initial title location is located at step 514. At step 516, the read head is positioned over the initial title location. At step 518, data is read from the DVD at that location.

It will be understood, and is appreciated by persons skilled in the art, that one or more processes, sub-processes, or process steps described in connection with FIGS. 1-5 may be performed by hardware and/or software. If the process is performed by software, the software may reside in software memory (not shown) in a suitable electronic processing component or system such as, one or more of the functional components or modules schematically depicted in FIGS. 1-5. The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any means that may contain, store or communicate the program for use by or in connection with the instruction execution system, apparatus, or device. The computer readable medium may selectively be, for example, but is not limited to, an electronic, magnetic, optical, electromagnetic, infrared, or semiconductor system, apparatus or device. More specific examples, but nonetheless a non-exhaustive list, of computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The foregoing description of an implementation has been presented for purposes of illustration and description. It is not exhaustive and does not limit the claimed inventions to the precise form disclosed. Modifications and variations are possible in light of the above description or may be acquired from practicing the invention. For example, the described implementation includes software but the invention may be implemented as a combination of hardware and software or in hardware alone. Note also that the implementation may vary between systems. The claims and their equivalents define the scope of the invention.

1. A system for playing audio only in a disk player configured to read data from disks formatted according to a selected audio and video standard, the system comprising:
a file reader to read files of audio and video files based on the audio and video standard;
a stream parser to identify audio data, video data and sub-picture data;
an audio decoder to decode the audio data according to the audio standard;
a video stub to receive the video data and leave the video data unprocessed;
a sub-picture menu processor to extract menu information; and
a user interface system to use the menu information to configure at least one user input to play audio-only from the disk according to the menu information.

2. The system of claim 1 further comprising a text formatter to convert the menu information to text for display on a text display.

3. The system of claim 1 further comprising a controller to receive a signal from the at least one user input and to control the disc player to play audio only from a location on the disc according to the user input.

4. The system of claim 3 comprising:
a plurality of user control inputs corresponding to a control function selected from a power on/off function, a next chapter function, a previous chapter function, a play function, a stop/pause function, a go to function, and a trick play function.

5. The system of claim 1 further comprising:
a human-machine interface to control audio-only playback according to audio track information received from the disc and based on user inputs.

6. The system of claim 1 further comprising:
a chapter locations database containing audio track information related to a user control input, the chapter locations database being used by the user interface system to control the disk player based on functions corresponding to the user inputs.

7. The system of claim 1 further comprising:
a multimedia engine connected to a disc player application, the multi-media engine including a media detect module to detect a disc insertion in the disc player, the media detect module including the stream parser, the multi-media engine configured to provide the disc player application with audio track information.

8. The system of claim 7 wherein the multi-media engine includes an interface to a database and functions to store audio track information in the database when a disc is inserted.

9. The system of claim 8 where the multi-media engine includes an interface to a human-machine interface, the multi-media engine configured to communicate audio track information to the human machine interface.

10. The system of claim 1 further comprising:
a user interface panel having a plurality of buttons having a function for navigating the audio tracks.

11. The system of claim 10 wherein the user interface panel further includes:
a text display for displaying text identifying audio track locations corresponding to the buttons on the panel.

12. A method for audio-only playback of a disc having audio and video information, the method comprising:
parsing the audio and video information to identify video information, audio information and sub-picture data;
decoding the audio data;
leaving the video information unprocessed;
extracting menu information in the sub-picture data;
using the menu information to obtain audio track information;
storing the audio track information and associating the audio track information with user input in a database; and
receiving the user input from a user to select an audio track to play and initiating playback at the audio track.

13. The method of claim 12 where the step of receiving the user input comprises:
waiting for the user input;
testing the user input for audio play instructions;
retrieving audio track location information based on the audio play instruction;
positioning a disc player read head at the audio track location; and
reading data from the disc.

14. A computer readable medium having software for providing audio-only playback capability of a disc comprising:
logic configured for parsing the audio and video information to identify video information, audio information and sub-picture data;
logic configured for decoding the audio data;
logic configured for leaving the video information unprocessed;
logic configured for extracting menu information in the sub-picture data;
logic configured for using the menu information to obtain audio track information;
logic configured for storing the audio track information and associating the audio track information with user input in a database; and
logic configured for receiving the user input from a user to select an audio track to play and initiating playback at the audio track.

15. The computer readable medium of claim 14 where the logic configured for receiving the user input comprises:
logic configured for waiting for the user input;
logic configured for testing the user input for audio play instructions;
logic configured for retrieving audio track location information based on the audio play instruction;
logic configured for positioning a disc player read head at the audio track location; and
logic configured for reading data from the disc.

16. A disc player comprising:
a read bead coupled to a file reader to read files of audio and video files based on an audio and video standard;
a user interface panel having a plurality of buttons for controlling operation of the disc player;
a controller to receive user inputs via the plurality of buttons and to control audio playback based on the user inputs, the controller having:
a stream parser to identify audio data, video data and sub-picture data;
an audio decoder to decode the audio data according to the audio standard;
a video stub to receive the video data and leave the video data unprocessed;
a sub-picture menu processor to extract menu information; and
a human machine interface to configure at least one user input to play audio-only from the disk according to the menu information.

17. The disc player of claim 16 where the controller receives a signal from the at least one user input and to control the disc player to play audio from a location on the disc according to the user input.

18. The system of claim 17 comprising:
a plurality of user control inputs corresponding to a control function selected from a power on/off function, a next chapter function, a previous chapter function, a play function, a stop/pause function, a go to function, and a trick play function.
